(19) United States
(12) Patent Application Publication
(10) Pub. No.: US 2017/0250032 A1
(43) Pub. Date: Aug. 31, 2017

(54) Hybrid Supercapacitor

(71) Applicant: Robert Bosch GmbH, Stuttgart (DE)

(72) Inventors: Elisabeth Buehler, Tamm (DE); Mathias Widmaier, Magstadt (DE); Pallavi Verma, Leinfelden (DE); Severin Hahn, Kirchheim u.T. (DE); Thomas Eckl, Leonberg (DE)

(21) Appl. No.: 15/440,695

(22) Filed: Feb. 23, 2017

(30) Foreign Application Priority Data
Feb. 25, 2016 (DE) 10 2016 202 979.7

(51) Int. Cl. H01G 11/04; H01G 11/60; H01G 11/32; H01G 11/62

(52) U.S. Cl. CPC H01G 11/04; H01G 11/62; H01G 11/60; H01G 11/32

(57) ABSTRACT

A supercapacitor has a cathode and an anode. At least one of the cathode and the anode of the supercapacitor contains at least one material which stores polyvalent cations. Additionally, the supercapacitor also has an electrolyte. The electrolyte contains an electrolyte salt, and the electrolyte salt has at least one polyvalent cation.

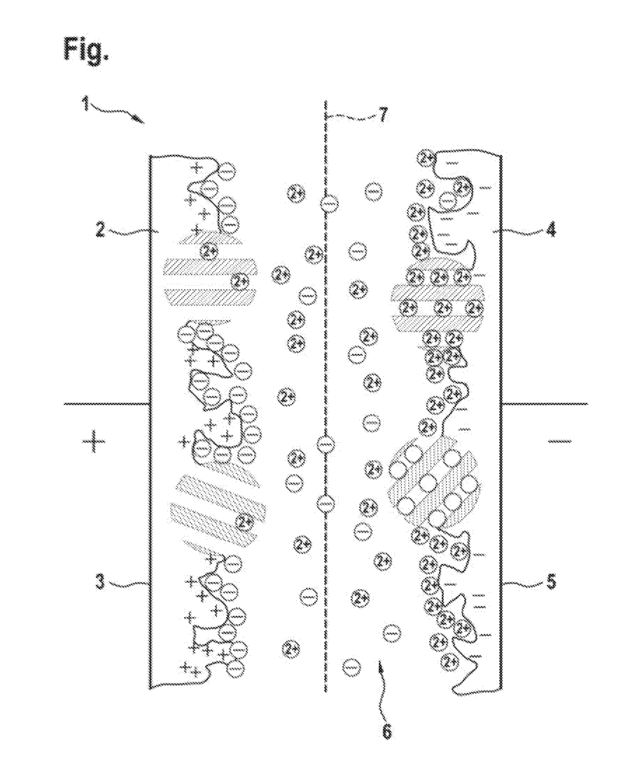

This application claims priority under 35 U.S.C. §119 to patent application number DE 10 2016 202 979.7, filed on Feb. 25, 2016 in Germany, the disclosure of which is incorporated herein by reference in its entirety.

### BACKGROUND

The present disclosure relates to a hybrid supercapacitor.

High-energy supercapacitors (EDLCs/SCs) can make a power density of more than 100 kW/kg available. For this purpose, they have electrodes which are either capacitively active or contain salts of monovalent cations having faradaic activity, for example lithium salts, which are intercalated in materials having a low capacitive efficiency, for example graphite.

To increase their energy density, supercapacitors can be configured as hybrid supercapacitors (HSCs), for example as lithium ion capacitors. A mixture of a plurality of chemical substances having both faradaic and capacitively active materials, which is bonded by means of a binder to form a hybridized electrode, is used as electrode material for hybrid supercapacitors.

Hybrid supercapacitors can, depending on the cell structure, be divided into two different categories: symmetric and asymmetric hybrid supercapacitors. Asymmetric hybrid supercapacitors have an electrode whose material stores energy by means of a reversible faradaic reaction. This can be a hybridized electrode. The second electrode is purely capacitive, i.e. it stores energy by formation of a Helmholz double layer. This structure is customary especially for first-generation hybrid supercapacitors, since it has an electrode configuration which corresponds to the structure of lithium ion battery electrodes or supercapacitor electrodes, so that known electrode production processes can be utilized. Lithium ion capacitors are an example of an asymmetric hybrid supercapacitor. Symmetric hybrid supercapacitors have two internally hybridized electrodes having both faradaic and capacitively active materials. This combination enables the energy density to be increased considerably compared to conventional supercapacitors. Furthermore, synergistic effects between the two active electrode materials can be utilized in both electrodes. Symmetric hybrid supercapacitors are superior to asymmetric hybrid supercapacitors in pulsed operation.

### SUMMARY

The cathode and/or anode of the hybrid supercapacitor contains at least one material which stores polyvalent cations. This material can be an ion-storing pseudocapacitive material. When only one of the two electrodes contains a material which stores polyvalent cations, the capacitor is an asymmetric hybrid supercapacitor. If, on the other hand, both electrodes contain a material which stores polyvalent cations, the capacitor is a symmetric hybrid supercapacitor. The electrolyte of the hybrid supercapacitor contains at least one solvent in which at least one electrolyte salt is dissolved. The electrolyte salt contains at least one polyvalent cation, i.e. a cation having a charge of 2+ or higher. The high effective ionic conductivity of polyvalent cations gives the hybrid supercapacitor improved performance compared to conventional supercapacitors since more rapid ionic charge transport is made possible.

The polyvalent cation is preferably selected from the group consisting of Ca²⁺, Mg²⁺, Ba²⁺, Sr²⁺, Zn²⁺, Cu²⁺, Fe²⁺, Mn²⁺, Ni²⁺, Co²⁺, Al³⁺, V³⁺, Y³⁺ and mixtures thereof. These cations have small ionic radii. In addition, some of these cations have low absolute electrochemical ionization potentials, which makes broad utilization of the stable voltage window of conventional electrolytes possible. The polyvalent cation is particularly preferably selected from the group consisting of Mg²⁺, Ba²⁺, Zn²⁺, Cu²⁺, Fe²⁺, Ni²⁺, Co²⁺, Al³⁺, V³⁺, Y³⁺ and mixtures thereof. The ionic radius of these cations is in some cases below 90 pm and thus below the ionic radius of Li⁺. These cations can therefore even penetrate into pores of a capacitive electrode material which are too small for the Li⁺ ions frequently used in conventional supercapacitors and hybrid supercapacitors.

The electrolyte salt preferably contains at least one anion selected from the group consisting of (CF₃SO₂)₂N⁻ (also referred to as TFSI), ClO₄⁻, BF₄⁻, and PF₆⁻. Salts of these anions have good solubility in solvents which are suitable for the electrolytes of hybrid supercapacitors. They also do not undergo any undesirable reactions with the electrode materials.

The solvent of the electrolyte is preferably selected from the group consisting of acetonitrile, propylene carbonate, ionic liquids, water and mixtures thereof. These solvents make it possible, particularly together with an electrolyte salt containing the preferred cations and/or anions, to form an organic or aqueous hybrid supercapacitor electrolyte.

The ion-storing material of the cathode is preferably selected from the group consisting of NiHCF, CuHCF, K₂BaFe(CN)₆, VO₂, V₂O₅, MnₓCo_{y}O₄ and mixtures thereof, where 2.50<x+y<2.62. In particular, x=2.15 and y=0.37. NiHCF, CuHCF and K₂BaFe(CN)₆ have a Prussian blue structure. This open crystal structure is particularly also highly suitable for hybrid supercapacitors containing aqueous electrolytes, since it makes the reversible intercalation of polyvalent cations from aqueous solution possible. VO₂, V₂O₅ and Mn_{2.15}Co_{0.37}O₄ are compounds having extensively studied intercalation behavior and make reversible intercalation reactions, particularly from nonaqueous electrolytes, possible.

The cation-storing material of the anode is preferably β-SnSb which can reversibly store, inter alia, Mg²⁺ ions. The ion-storing material of the anode is preferably in the form of nanoparticles in order to give it a high surface area.

When the cation-storing material is a pseudocapacitive material, it is preferably selected from the group consisting of MnO₂, polymeric materials, in particular polyaniline (PANI) or polypyrrole (PPy), and mixtures thereof. Pseudocapacitive materials increase the capacitance of the electrodes.

The material of the cathode and/or of the anode which stores polyvalent cations can be mixed with purely capacitive materials. In this way, the electrode can be configured as a purely capacitive electrode, as a purely faradaic electrode or as a hybridized electrode. If it is configured as a purely capacitive electrode or as a hybridized electrode, it has an increased capacitance compared to a comparable conventional cathode which stores monovalent cations. The purely capacitive material is preferably selected from the group consisting of carbon nanotubes, carbon nanofibers, graphene, functionalized graphene, activated carbon and mixtures thereof. These carbon modifications make, as electrode constituent, rapid energy provision by the electrode possible, since they improve the electrical conductivity of the electrodes. Owing to the high porosity of the carbon modifications used, they can additionally function as shock absorbers for high currents as a result of absorption of ions on the surface.

The cathode and/or the anode can preferably contain graphite and/or nanoparticles of carbon. This increases the electrical conductivity of the electrode. The graphite and/or the carbon nanoparticles can also be, at least in part, applied as coating to the cathode materials and/or anode materials.

To join a plurality of components of the cathode and/or of the anode to one another, each of these electrodes can additionally contain at least one binder.

### BRIEF DESCRIPTION OF THE DRAWINGS

A working example of the disclosure is shown in the FIGURE and is described in more detail in the following description.

The FIGURE schematically shows the structure of a supercapacitor according to a working example of the disclosure, which is configured as symmetric hybrid supercapacitor.

### DETAILED DESCRIPTION

A supercapacitor 1 according to a working example of the disclosure is configured as symmetric hybrid supercapacitor. It has the structure depicted in the figure. A cathode 2 has been applied to a first collector 3. An anode 4 has been applied to a second collector 5. An electrolyte 6 has been introduced between the cathode 2 and the anode 4. A separator 7 separates the cathode 2 from the anode 4. Embedding of Mg²⁺ ions into the cathode 2 and into the anode 4 is shown schematically as an example of polyvalent cations in the figure. Here, the figure shows activated carbon as capacitive electrode material on the surface of which, during charging, negative charge carriers of the electrolyte 6 accumulate at the cathode 2 and on the surface of which positive charge carriers of the electrolyte 6 accumulate at the anode 4. Furthermore, four enlargements show how the magnesium ion cathode material of the cathode 2, in the present case Mn_{2.15}Co_{0.37}O₄, deintercalates Mg²⁺ ions and the magnesium ion anode material of the anode 4, in the present case β-SnSb, stores Mg²⁺ ions by alloying.

To produce the cathode 2, a mixture of 66.83 g of activated carbon, 15.67 g of Mn_{2.15}Co_{0.37}O₄ particles coated with carbon nanoparticles, 5 g of graphite particles and 5 g of carbon nanoparticles is firstly produced. This is drymixed at 1000 rpm in a mixer for 10 minutes. 90 ml of isopropanol are then added and the suspension obtained is firstly stirred at 2500 rpm for 2 minutes, then treated with ultrasound for 5 minutes and subsequently stirred at 2500 rpm again for 4 minutes. 7.5 g of polytetrafluoroethylene (PTFE) are subsequently added as binder to the suspension and the mixture is again stirred at 800 rpm for 5 minutes until the suspension takes on a paste-like consistency. The paste is rolled out on a glass plate to give a 150 μm thick cathode 2 which is then applied to the first collector 3.

To produce the anode 4, a mixture of 66.83 g of activated carbon, 15.67 g of β-SnSb particles coated with carbon nanoparticles, 5 g of graphite particles and 5 g of carbon nanoparticles is firstly produced. This is drymixed at 1000 rpm in the mixer for 10 minutes. 90 ml of isopropanol are then added and the suspension obtained is firstly stirred at 2500 rpm for 2 minutes, then treated with ultrasound for 5 minutes and subsequently stirred at 2500 rpm again for 4 minutes. 7.5 g of polytetrafluoroethylene are subsequently added as binder to the suspension and the mixture is stirred again at 800 rpm for 5 minutes until the suspension takes on a paste-like consistency. The paste is rolled out on a glass plate to give a 150 μm thick anode 4 which is then applied to the second collector 5.

A 1 M solution of Mg(TFSI)₂ in a solvent mixture of 83% by volume of acetonitrile and 17% by volume of water is used as electrolyte 6. The separator 7 consists of a woven polyamide/polyethylene terephthalate/cellulose fabric having a porosity of 62%.

The supercapacitor has a high energy density and a high power density.

What is claimed is:

1. A hybrid supercapacitor comprising:
a cathode;
an anode; and
an electrolyte, wherein:
at least one of the cathode and the anode contains at least one material which stores polyvalent cations, and
the electrolyte contains an electrolyte salt having at least one polyvalent cation.

2. The hybrid supercapacitor according to claim 1, wherein the at least one polyvalent cation is selected from the group consisting of Ca²⁺, Mg²⁺, Ba²⁺, Sr²⁺, Zn²⁺, Cu²⁺, Fe²⁺, Mn²⁺, Ni²⁺, Co²⁺, Al³⁺, V³⁺, Y³⁺ and mixtures thereof.

3. The hybrid supercapacitor according to claim 1, wherein the electrolyte salt contains at least one anion selected from the group consisting of (CF₃SO₂)₂N⁻, ClO₄⁻, BF₄⁻, and PF₆⁻.

4. The hybrid supercapacitor according to claim 1, wherein the electrolyte contains a solvent selected from the group consisting of acetonitrile, propylene carbonate, at least one ionic liquid, water and mixtures thereof.

5. The hybrid supercapacitor according to claim 1, wherein the at least one material of the cathode which stores polyvalent cations is selected from the group consisting of NiHCF, CuHCF, K₂BaFe(CN)₆, VO₂, V₂O₅, MnₓCo_{y}O₄ and mixtures thereof, where 2.50<x+y<2.62.

6. The hybrid supercapacitor according to claim 1, wherein the at least one material of the anode which stores polyvalent cations contains β-SnSb.

7. The hybrid supercapacitor according to claim 1, wherein the at least one material of the at least one of the cathode and the anode which stores polyvalent cations is a pseudocapacitive material selected from the group consisting of MnO₂, polymeric materials and mixtures thereof.

8. The hybrid supercapacitor according to claim 1, wherein the at least one of the cathode and the anode additionally contains a capacitive material selected from among carbon nanotubes, carbon nanofibers, graphene, functionalized graphene, activated carbon and mixtures thereof.

9. The hybrid supercapacitor according to claim 1, wherein the at least one of the cathode and the anode contains graphite and/or nanoparticles of carbon.
